(19) United States
(12) Patent Application Publication
(10) Pub. No.: US 2006/0103169 A1
(43) Pub. Date: May 18, 2006

(54) Tunnel bridge for a motor vehicle

(76) Inventor: Michael Anders, Althengstett (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 11/272,846

(22) Filed: Nov. 14, 2005

(30) Foreign Application Priority Data
Nov. 16, 2004 (DE) 102004055197.9-42

(51) Int. Cl. B62D 25/00

(52) U.S. Cl. 296/193.01

(57) ABSTRACT

The invention relates to a tunnel bridge (1) of a motor vehicle with a support structure (4) featuring at least two side parts (2, 3) and ribs (5) at least at the side parts (2, 3) in which the tunnel bridge (1) is adapted to be connected to the body and/or beams (6, 7) of the motor vehicle. For the known tunnel bridges this would be detrimental. A significant improvement is achieved by a tunnel bridge (1) which is constituted as one piece made from a cast material together with the associated side parts (2, 3) and/or the connecting parts for the connection to the body and that the ribs (5) are located at the side parts (2, 3) and/or on a tunnel bridge part (8) which connects the side parts (2, 3).

### BACKGROUND OF THE INVENTION

1. Field of the Invention

The invention relates to a tunnel bridge of a motor vehicle with a support structure featuring at least two side parts and ribs at least at the side parts in which the tunnel bridge can be connected to the body and/or beams of the motor vehicle.

2. Related Art of the Invention

DE 42 13 130 A1 discloses a beam part for a light metal body of a motor vehicle with a housing consisting of two cast light metal shells which constitute a hollow section-like beam. In order to stiffen the hollow section stiffeners are formed as reinforcement ribs onto the inner walls of the two cast light metal shells, such that the reinforcement ribs run as narrow, plate-like webs across a large part of the of the transverse section of the hollow section with an alignment transverse to the longitudinal axis of the beam part and with one narrow side sticking out into the cavity in the height of their ribs. While maintaining a simple and cost efficient fabrication, this prevents collapsing of the beam cross-section causing a reduction of the beam stiffness at high loads for example during a vehicle crash.

A tunnel cover for a motor vehicle with a support structure is disclosed in DE 198 26 943 C2 which features at least one receiving space and at least one approximately vertically aligned longitudinal wall. At the one-piece support structure a sidewall element is attached which is associated with the longitudinal wall of the support structure, and which in sections together with the longitudinal wall of the support structure borders one or multiple hollow spaces. For this a ribbing is located between the support structure and a side wall element which is constituted as one piece with the support structure or the side wall element. The support structure, the side wall element and the ribbing are connected together non-detachably.

### SUMMARY OF THE INVENTION

The objective of the invention is to design and arrange at the least parts of the vehicle frame such that it can be fabricated as a lower cost lightweight construction.

According to the invention this objective is accomplished in that (1) a tunnel bridge is constituted as one piece made from a cast material together with the associated side parts and/or the connecting parts for the connection to the body, and that the ribs are located at the side parts and/or on a tunnel bridge part which connects the side parts.

Thereby it is achieved that the tunnel bridge with all associated connecting parts, like flange feet, flange parts and webs, can be fabricated as a single casting which can be made from Al or a steel alloy and which can easily be adjusted to other vehicle bodies or, as the case may be, body parts.

For this it is advantageous that (2) the ribs which are located at the side parts and/or at the tunnel bridge part connecting the side parts are arranged vertically with respect to the footprint of the vehicle and/or the surface of the side part. Through the advantageous placement of the differently shaped ribs a lightweight design of the tunnel bridge is feasible so that the wall thickness and with that the overall weight of the tunnel bridge can be reduced.

Further it is advantageous that (3) the ribs are aligned transverse with respect to a longitudinal centerline of the motor vehicle.

In an additional embodiment corresponding to a further development of the invention (4) the tunnel bridge part with the two side parts which are parallel to each other constitute an on its, with respect to the footprint of the vehicle, bottom side open U-shaped channel, which features one flange part each on its front and rear end respectively which is aligned transverse to the longitudinal centerline. Such a tunnel bridge is easily individually adjustable to other units and through the weight reduction of the tunnel bridge additional cost savings are realized.

It is advantageous that (5) webs or, as the case may be, flanges are connected to the side parts, which run approximately in parallel to the longitudinal centerline and with respect to the footprint of the vehicle approximately horizontally, and which are connected to the transversally running front and rear flange parts respectively transition into the vertically aligned flange parts. With the casting mold it is possible to locate the webs as well as the flange parts optimally on each suitable location on the tunnel bridge.

In a preferred embodiment of the invention (6) the ribs which are with their front face firmly attached to the side parts are also with their front face attached to the webs or, as the case may be, flanges of the tunnel bridge part, which enclose approximately a right angle with the side parts. The numerous advantageously shaped ribs contribute mainly to the stability and warp resistance of the tunnel bridge.

It is of special relevance for the invention, that (7) ribs which are aligned transverse to the longitudinal centerline are attached to the internal surfaces of the side parts and of the tunnel bridge part. Through this the torsional strength of the tunnel bridge is significantly improved.

In connection with the design and arrangement according to the invention it is of advantage, that (8) the internal ribs are connected through ribs which run approximately in parallel to the longitudinal centerline.

It is also advantageous, that (9) the individual ribs starting from the location of their attachment continuously taper towards the outside. This reduces material cost without reducing the stability of the tunnel bridge.

Moreover, it is advantageous that (10) the individual ribs feature a thickness between 1 mm and 14 mm or between 2 mm and 10 mm or between 3 mm and 8 mm.

Furthermore it is advantageous, that (11) the individual side parts or the tunnel bridge part feature a wall thickness between 2 mm and 15 mm or between 2 mm and 10 mm or between 2 mm and 5 mm. Through the different thicknesses of the ribs and the side parts of the tunnel bridge an individual adjustment to the different loads the tunnel bridge is exposed to is possible.

Further advantages and details of the invention are explained in the claims and in the description and illustrated in the following Figures.

### BRIEF DESCRIPTION OF THE DRAWINGS

They show:

FIG. 1 a perspective view of the vehicle body with a tunnel bridge part highlighted by a circle,

FIG. 2 a perspective view of the tunnel bridge in a view from the side and from the top,

FIG. 3 a perspective view of the tunnel bridge in a view from the side and from the rear,

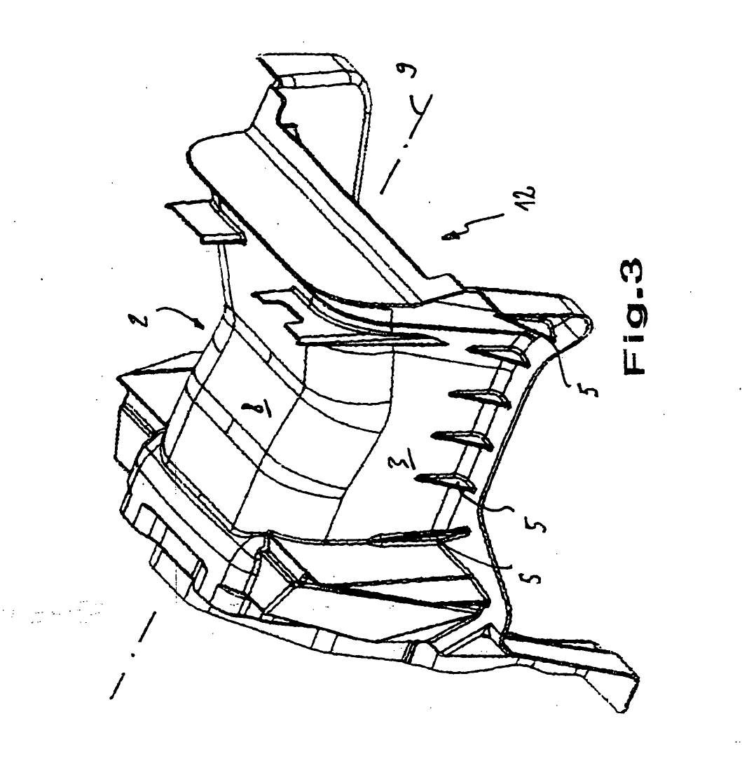

FIG. 4 a perspective view of the tunnel bridge in a view from the side and from below,

FIG. 5 A cross-sectional view of the tunnel bridge along line 2-2 according to FIG. 2

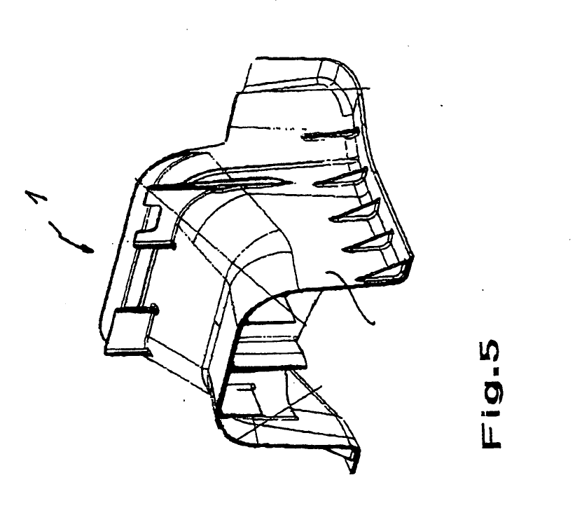

FIG. 6 A cross-sectional view of the tunnel bridge along line 1-1 according to FIG. 2

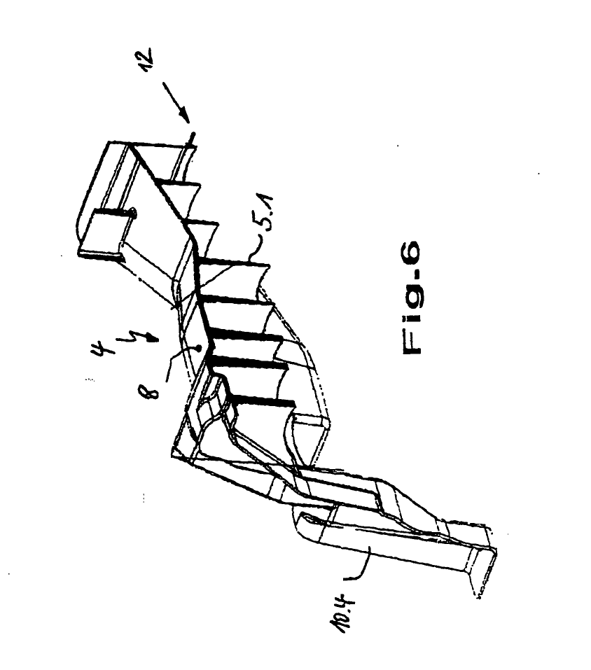

FIG. 7 A cross-sectional view of the tunnel bridge along line 3-3 according to FIG. 2

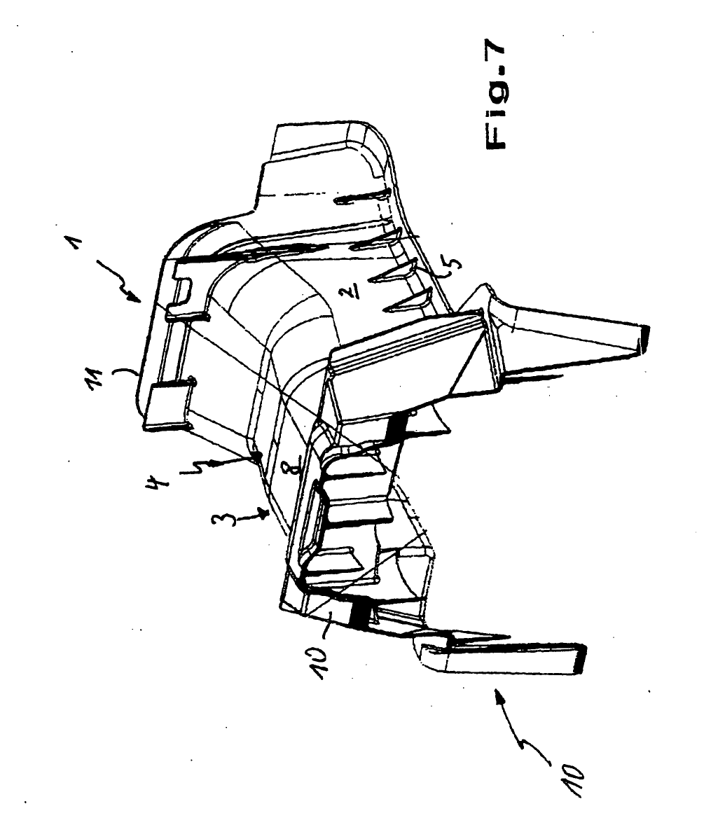

### DETAILED DESCRIPTION OF THE INVENTION

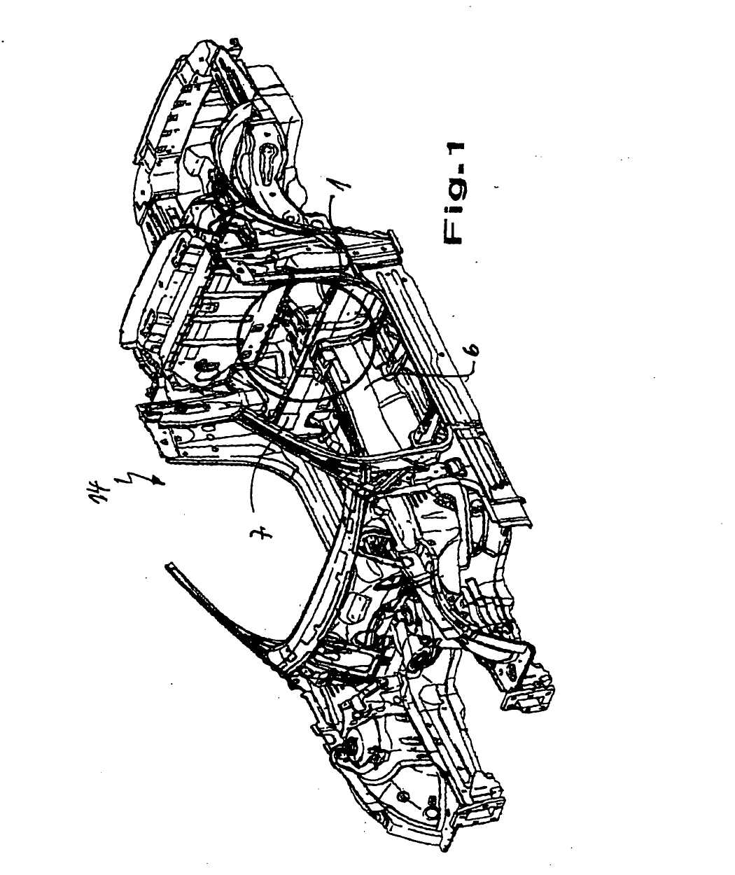

In FIG. 1 the vehicle body is only partly shown, wherein the tunnel bridge 1 according to the invention is highlighted by a circle. The tunnel bridge 1 in this embodiment is located behind the front seat row which is not shown in the drawing and it is firmly connected to the body by a beam 6 which is aligned in driving direction, by a transverse to the driving direction aligned beam 7 and by additional body parts of the motor vehicle which are not shown here.

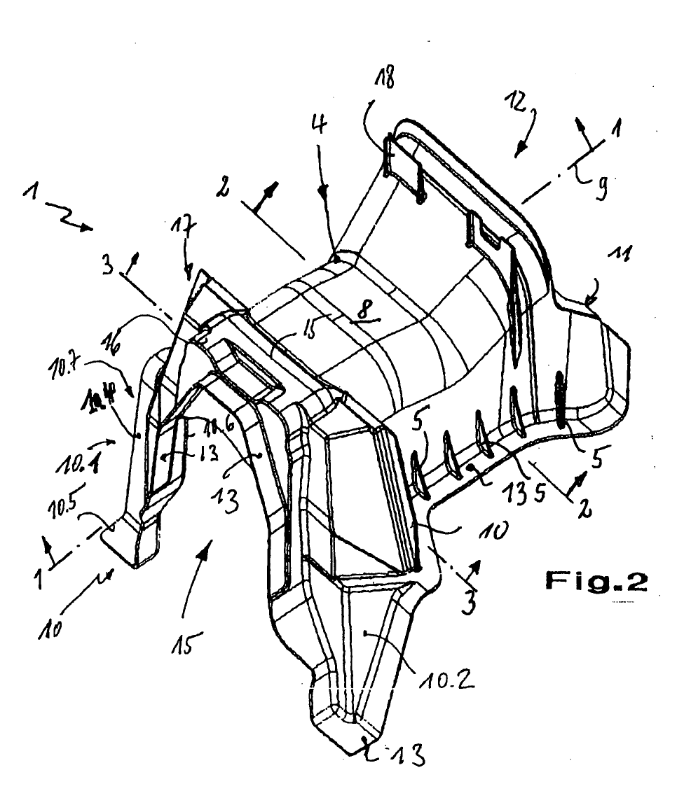

The tunnel bridge 1 of the motor vehicle forms a U-shaped channel 12 and consists mainly of two vertical side parts 2, 3 which run approximately in parallel and a tunnel bridge part 8 connecting the two side parts 2, 3 which runs horizontally with respect to the footprint of the vehicle. The tunnel bridge part 8 and the side parts 2, 3 constitute a support structure 4 which is fabricated as a one piece steel casting or aluminum casting and thereby allowing wall thicknesses between 2 mm and 15 mm or between 2 mm and 10 mm or between 2 mm and 5 mm while maintaining high strength and warp resistance. The other parts which are connected to the tunnel bridge 1 consist, as described below, of the same casting material so that they are connected to the tunnel bridge 1 as one piece and constitute as shown especially in FIG. 2 a single monolithic body.

The support structure 4 or, as the case may be, its side parts 2, 3 as well as the tunnel bridge part 8 connecting the side parts 2, 3 feature multiple ribs 5 which are aligned transverse with respect to a longitudinal centerline 9 of the motor vehicle. The ribs 5 on the outside of the side parts 2, 3 are approximately equidistant to each other and are parallel to each other. Depending on the load type the ribs 5 may be arranged with a smaller or larger distance to each other. Some of the ribs 5 are triangularly shaped, whereas the front faces of the ribs which are rectangular to each other are connected to side parts 2, 3 of the support structure 4 and to a web or, as the case may be, flange 13 which runs horizontally with respect to the foot print of the motor vehicle and which is connected with transverse front and rear flange parts 10, 11 as one piece respectively and gradually transitions into the at least partly vertically aligned flange parts 10, 11.

According to FIG. 2 the webs or, as the case may be, flanges 13 reach up to the flange part 10 and constitute with respect to the footprint of the motor vehicle a horizontal termination edge on the front.

The tunnel bridge 1 is connectable with other parts and the beams 6, 7 of the vehicle body which are only partly shown in the illustration. For this the tunnel bridge 1 features in is front region the flange part 10 which features the web constituting the horizontal termination edge on the front or, as the case may be, flange 13 which constitutes a U-shaped on its bottom open recess 15 which conforms with a gearbox tunnel which is not shown in the illustration so that the tunnel bridge 1 can be put on and attached to the gearbox or transmission tunnel.

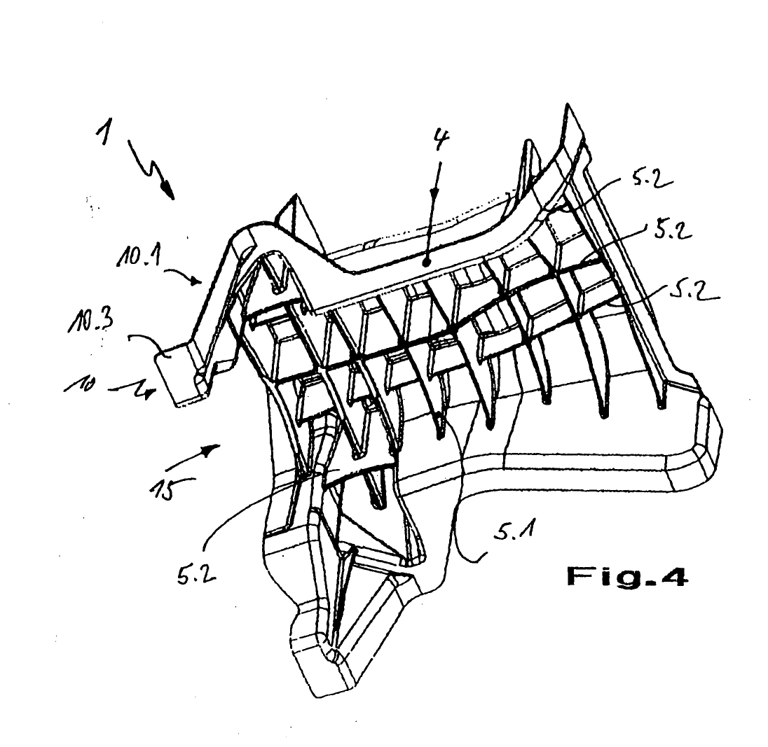

Furthermore the flange part 10 consists of a left and a right vertical leg 10.1 and 10.2. The left leg 10.1 consists according to FIGS. 1 and 4 of a housing part, slightly inclined towards the front, with a front wall 10.4 which transitions into a lower flange foot 10.5 and a rear wall 10.6. The two walls 10.4, 10.6 are connected by a sidewall 10.7 and a cross-bar or, as the case may be, a flange 13. The legs 10.1, 10.2 can be stiffened by internal ribs which are not shown in the illustration. The whole flange part 10 with all small flange parts is firmly connected with the tunnel bridge 1 and constitutes together with it a one piece casting.

According to FIG. 4 the internal sidewalls of the tunnel bridge 1 also feature numerous ribs 5.1 which are parallel to each other and are approximately perpendicularly aligned to the longitudinal centerline 9, and which connect the left and the right side parts 2, 3 and thereby strengthen the tunnel bridge 1. In this embodiment eight transversal ribs 5.1 are used, which are connected through at least three or more longitudinally or in parallel to the longitudinal centerline 9 running ribs 5.2 thus resulting in a high stability or, as the case may be, warp resistance of the tunnel bridge part 8.

Depending on the design of the tunnel bridge 1 either more or fewer ribs 5, 5.1, 5.2 can be integrated into the casting. The ribs 5 on the outside of the side parts 2, 3 and the ribs 5.1, 5.2 can be located on the same transversal level or with an offset to each other.

The individual ribs 5 exhibit a thickness between 1 mm and 14 mm or between 2 mm and 10 mm or between 3 mm and 8 mm. The ribs 5 can all feature the same or depending on the load type different thicknesses.

The tunnel bridge 1 also features flange parts 16, 17, 18 which are located at the top side of the tunnel bridge part 8, to which various units or body parts can be connected.

### REFERENCE NUMERAL LIST

| | |
|---|---|
| 1 | tunnel bridge |
| 2 | side part |
| 3 | side part |
| 4 | support structure |
| 5 | rib |
| 5.1 | rib |
| 5.2 | rib |
| 6 | beam |
| 7 | beam |
| 8 | tunnel bridge part |
| 9 | longitudinal centerline |
| 10 | flange part |
| 10.1 | leg |
| 10.2 | leg |
| 10.4 | wall |
| 10.5 | flange foot |
| 10.6 | rear wall |
| 10.7 | side wall |
| 11 | flange part |
| 12 | channel |
| 13 | web or flange |
| 15 | recess |
| 16 | flange part |
| 17 | flange part |
| 18 | flange part |

1. A tunnel bridge (1) of a motor vehicle, the tunnel bridge (1) comprising a support structure (4) featuring at least two side parts (2, 3) and ribs (5) at least at the side parts (2, 3), the tunnel bridge (1) adapted to be connected to the body and/or beams (6, 7) of the motor vehicle,
wherein
the tunnel bridge (1) is constituted as one piece made from a cast material together with the associated side parts (2, 3) and/or the connecting parts for the connection to the body, and the ribs (5) are located at the side parts (2, 3) and/or on a tunnel bridge part (8) which connects the side parts (2, 3).

2. The tunnel bridge according to claim 1,
wherein
the ribs (5) which are located at the side parts (2, 3) and/or at the tunnel bridge part (8) connecting the side parts (2, 3) are arranged vertically with respect to the footprint of the vehicle and/or the surface of the side part (3).

3. The tunnel bridge according to claim 1,
wherein
the ribs (5) are aligned transverse with respect to a longitudinal centerline (9) of the motor vehicle.

4. The tunnel bridge according to claim 1,
wherein
the tunnel bridge part (8) with the two side parts (2, 3) which are parallel to each other constitute an on its, with respect to the footprint of the vehicle, bottom side open U-shaped channel (12), which features one flange part (10, 11) each on its front and rear end respectively, each of which is aligned transverse to the longitudinal centerline (9).

5. The tunnel bridge according to claim 1,
wherein
bars or, as the case may be, flanges (13) are connected to the side parts (2, 3), which run approximately in parallel to the longitudinal centerline (9) and with respect to the footprint of the vehicle approximately horizontally, and which are connected to the transversally running front and rear flange parts (10, 11) respectively and transition into the vertically aligned flange parts (10, 11).

6. The tunnel bridge according to claim 1,
wherein
the ribs (5) which are firmly attached with their front face to the side parts (2, 3) are also with their front face attached to the webs or, as the case may be, flanges (13) of the tunnel bridge part (8), which describe approximately a right angle with the side parts (2, 3).

7. The tunnel bridge according to claim 1,
wherein
ribs (5) which are aligned transverse to the longitudinal centerline (9) are attached to the internal surfaces of the side parts (2, 3) and of the tunnel bridge part (8).

8. The tunnel bridge according to claim 1,
wherein
the ribs (5) are internal ribs connected through ribs (5.1) which run approximately in parallel to the longitudinal centerline (9).

9. The tunnel bridge according to claim 1,
wherein
the individual ribs (5), starting from the location of their attachment, continuously taper towards the outside.

10. The tunnel bridge according to claim 1,
wherein
the individual ribs (5) exhibit a thickness between 1 mm and 14 mm.

11. The tunnel bridge according to claim 1,
wherein
the individual side parts (2, 3) or the tunnel bridge part (8) feature a wall thickness between 2 mm and 15 mm.

12. A motor vehicle including a tunnel bridge (1) for providing space for a gearbox or transmission, the tunnel bridge (1) comprising a support structure (4) featuring at least two side parts (2, 3) and ribs (5) at least at the side parts (2, 3), the tunnel bridge (1) connected to the body and/or beams (6, 7) of the motor vehicle, wherein the tunnel bridge (1) is constituted as one piece made from a cast material together with the associated side parts (2, 3) and/or the connecting parts for the connection to the body, and wherein the ribs (5) are located at the side parts (2, 3) and/or on a tunnel bridge part (8) which connects the side parts (2, 3).

13. The tunnel bridge according to claim 1,
wherein
the individual ribs (5) exhibit a thickness between 2 mm and 10 mm.

14. The tunnel bridge according to claim 1,
wherein
the individual ribs (5) exhibit a thickness between 3 mm and 8 mm.

15. The tunnel bridge according to claim 1,
wherein
the individual side parts (2, 3) or the tunnel bridge part (8) feature a wall thickness between 2 mm and 10 mm.

16. The tunnel bridge according to claim 1,
wherein
the individual side parts (2, 3) or the tunnel bridge part (8) feature a wall thickness between 2 mm and 5 mm.
